(19) United States
(12) Patent Application Publication
(10) Pub. No.: US 2010/0083638 A1
(43) Pub. Date: Apr. 8, 2010

(54) Exhaust system having sulfur removing device

(76) Inventors: James Joshua Driscoll, Dunlap, IL (US); Anthony Rodman, Langtoft (GB)

Correspondence Address: CATERPILLAR/FINNEGAN, HENDERSON, L.L.P., 901 New York Avenue, NW, WASHINGTON, DC, 20001-4413, US

(21) Appl. No.: 12/285,496

(22) Filed: Oct. 7, 2008

(51) Int. Cl. F02M 25/06; F01N 3/00

(52) U.S. Cl. 60/278; 60/295

(57) ABSTRACT

An exhaust system for an engine is disclosed. The exhaust system may include a passageway configured to receive exhaust from the engine, and a recirculation circuit. The recirculation circuit is configured to recirculate exhaust from the passageway back into the engine. The exhaust system may also include an SOₓ removing device disposed within the passageway upstream of the recirculation circuit, and a filter disposed within the passageway to remove particulate matter from the exhaust. The exhaust system may further include a regeneration device configured to substantially simultaneously regenerate the SOₓ removing device and the filter.

### TECHNICAL FIELD

The present disclosure relates generally to an exhaust system and, more particularly, to an exhaust system having a sulfur removing device.

### BACKGROUND

Power systems that employ combustion engines to produce power also produce exhaust gases that include a complex mixture of air pollutants. Due to increased attention given to the environment, exhaust-emission standards have become more stringent, and the amount and contents of the exhaust emitted to the atmosphere from an engine may be regulated according to the type of engine, size of engine, and/or class of engine. Exhaust-Gas Recirculation (EGR) systems have been used to improve emissions control in order to comply with the regulations. A low pressure EGR system typically includes an exhaust recirculation passageway having one end connected to an exhaust system to receive exhaust from downstream of a particulate filter, a catalyst, or other treatment device, and another end connected with an intake of the engine. Within the recirculation passageway of the EGR system, there is typically a cooling device for reducing the temperature of the recycled exhaust. In this configuration, the EGR system recirculates or recycles a cooled portion of the engine exhaust back into the intake of the engine. The recycled exhaust is then mixed with the intake air, thereby diluting the in-cylinder composition and lowering the combustion temperature. As a result, NOₓ formation and NOₓ emission may be reduced.

The pollutants in the exhaust may include, among other things, sulfur oxides (SOₓ) (i.e., SO₂ and SO₃), which may oxidize and hydrate to form sulfuric acid (H₂SO₄) that condenses when cooled, for example, by the cooling device in the EGR passageway. The condensed sulfuric acid may attach to the relatively cool surfaces of the cooling device and downstream portions of the passageway, and cause corrosion of these components. Furthermore, when the sulfuric acid is directed into the engine with the recycled exhaust, the sulfuric acid may also attach to engine components, leading to degradation and decreased life span of the engine components.

In order to help minimize damage to EGR engine components, it may be desirable to remove SOₓ from engine exhaust before it has an opportunity to condense. One example of removing SOₓ from engine exhaust is described in U.S. Patent Application Publication No. 2007/0297961 A1 (the '961 patent application). In particular, the '961 patent application discloses a system including an SOₓ-removing device disposed upstream of EGR components to remove SOₓ from the exhaust before the exhaust is directed to the EGR components. The SOₓ-removing devices contain compounds that have a capacity for adsorption or absorption of SOₓ. The compounds include Magnesium (Mg), Calcium (Ca), Strontium (Sr), Manganese (Mn), Barium (Ba), or Lithium (Li). Due to the high affinity of these compounds for sulfur oxides, the SOₓ-removing devices are periodically replaced by new SOₓ-removing devices when the existing SOₓ-removing devices become saturated.

Although the system disclosed in the '961 patent application may help remove some SOₓ from the exhaust, thereby helping protect the EGR components from corrosion, the system may be expensive and burdensome to maintain. Specifically, in order to replace the SOₓ removing devices, the engine may need to be shut down, causing inconvenience and machine downtime loss. In addition, removing the SOₓ removing devices from the exhaust system and replacing the SOₓ removing devices may be time consuming, labor intensive, and costly.

The exhaust system of the present disclosure is directed toward improvements in the existing technology.

### SUMMARY

In one aspect, the present disclosure is directed to an exhaust system for an engine. The exhaust system may include a passageway configured to receive exhaust from the engine and a recirculation circuit. The recirculation circuit is configured to recirculate exhaust from the passageway back into the engine. The exhaust system may also include an SOₓ removing device disposed within the passageway upstream of the recirculation circuit, and a filter disposed within the passageway to remove particulate matter from the exhaust. The exhaust system may further include a regeneration device configured to substantially simultaneously regenerate the SOₓ removing device and the filter.

In another aspect, the present disclosure is directed to a method of treating exhaust from an engine. The method may include removing SOₓ from the exhaust. The method may also include directing SOₓ-reduced exhaust back into the engine. The method may also include collecting particulate matter from the exhaust. The method may further include heating the exhaust to substantially simultaneously improve an SOₓ removal capacity and reduce an amount of collected particulate matter.

### BRIEF DESCRIPTION OF THE DRAWINGS

FIG. 1 is a schematic illustration of an exemplary disclosed power system; and

FIG. 2 is a schematic illustration of an exemplary exhaust treatment device that may be employed in the disclosed power system of FIG. 1.

### DETAILED DESCRIPTION

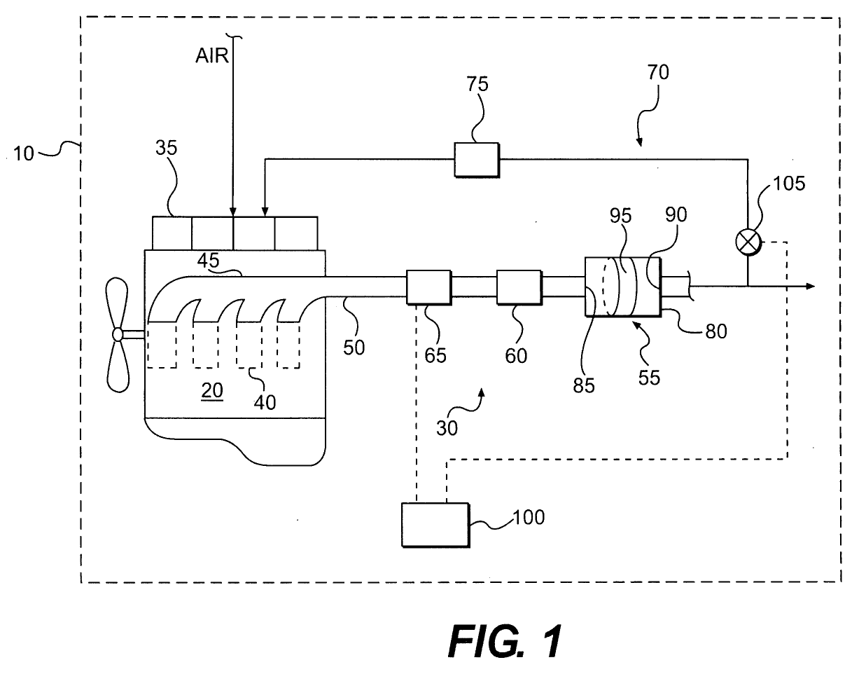

FIG. 1 illustrates an exemplary power system 10 that may be employed in vehicles, machines, or power plants, and that generates power by combusting air and fuel within an engine 20. Engine 20 may be any suitable combustion engine, for example, a diesel engine, a gasoline engine, a gaseous fuel powered engine, etc. Power system 10 may also include an exhaust system 30 for treating exhaust produced by engine 20.

Engine 20 may include a plurality of cylinders 40 forming combustion chambers for combusting a mixture of air and fuel. Engine 20 may also include an exhaust manifold 45, which may collect exhaust from cylinders 40 and direct the exhaust through exhaust system 30 to the atmosphere. Exhaust system 30 may include a passageway 50 configured to receive exhaust from exhaust manifold 45, and a recirculation circuit 70 configured to recirculate a portion of the exhaust from passageway 50 back into engine 20 by way of an intake manifold 35. Recirculation circuit 70 may include a valve 105 configured to inhibit or allow the exhaust from passageway 50 to flow through recirculation circuit 70. Operation of valve 105 may be regulated by a controller 100. Recirculation circuit 70 may also include one or more cooling devices 75 configured to reduce the temperature of the exhaust flowing therethrough. The exhaust directed back to engine 20 by way of recirculation circuit 70 may be mixed with the air directed into engine 20, thereby diluting the in-cylinder composition and causing a reduction in NOₓ generation.

A plurality of exhaust treatment devices may be disposed within passageway 50 upstream of recirculation circuit 70. The exhaust treatment devices may include, for example, an SOₓ removing device 55 configured to remove SOₓ from the exhaust, a filter 60 configured to remove particulate matter from the exhaust, and a regeneration device 65 configured to substantially simultaneously regenerate SOₓ removing device 55 and filter 60. SOₓ removing device 55 may be an SOₓ adsorbing or absorbing device. Filter 60 may also be referred to as a particulate filter, which may include a filtration substrate (not shown) to collect particulate matter from the exhaust and thus reduce an amount of particulate matter within the exhaust. Regeneration device 65 may be any suitable heating device, such as a fuel-fired burner or electric grid.

Among the various exhaust treatment devices within passageway 50, at least SOₓ removing device 55 may be disposed upstream of recirculation circuit 70. In some embodiments, each of SOₓ removing device 55, filter 60, and regeneration device 65 may be disposed upstream of recirculation circuit 70, as shown in FIG. 1. Thus, recirculation circuit 70 may draw exhaust from a location within passageway 50 downstream of SOₓ removing device 55. SOₓ removing device 55 may be disposed downstream of filter 60. This may be desirable to prevent particulate matter from attaching to a substrate (discussed below) of SOₓ removing device and adversely affecting the SOₓ removing capacity. Regeneration device 65 may be located upstream of SOₓ removing device 55 and filter 60. Although not shown, it is contemplated that in some embodiments, filter 60 may be disposed downstream of recirculation circuit 70. That is, recirculation circuit 70 may draw exhaust from a location within passageway 50 downstream of SOₓ removing device 55 and upstream of filter 60.

SOₓ removing device 55 may include a housing 80 having an inlet 85 and an outlet 90 for directing the exhaust through SOₓ removing device 55. SOₓ removing device 55 may contain an SOₓ removing material capable of adsorbing or absorbing SOₓ from the exhaust. The SOₓ removing material may be coated, e.g., washcoated, on a substrate 95 disposed within housing 80 of SOₓ removing device 55. Substrate 95 may be any suitable substrate known in the art. The SOₓ removing material may include any suitable base metal, such as Iron (Fe), Copper (Cu), Aluminum (Al), etc., or may include a combination of those base metals. When the exhaust passes through SOₓ removing device 55, the exhaust may come into contact with the SOₓ removing material and SOₓ within the exhaust may react with the SOₓ removing material to form sulfur compounds, such as Fe₂(SO₄)₃ (iron-sulfate), CuSO₄ (copper-sulfate), Al₂(SO₄)₃ (aluminum-sulfate), etc., depending on the base metal content of the SOₓ removing material. As a result, SOₓ may be removed from the exhaust and stored as sulfates. Stable sulfates are stored on catalyst sites, reducing the number of active sites over time. Thus, after a period of time in service, the removal capacity of SOₓ removing device 55 may be significantly reduced.

Filter 60 and SOₓ removing device 55 may be regenerated by regeneration device 65. That is, regeneration device 65 may heat the exhaust passing through filter 60 to burn away the particulate matter collected therein. This burning away of the particulate matter may start, for example, at about 500° C., and may become more effective as the temperature is increased, for example, to at about 600° C. or higher. The regeneration of filter 60 may be completed within a time frame of, for example, 5-20 minutes, while power system 10 is operating normally. It is to be understood that, when heating filter 60, regeneration device 65 may increase the temperature of the exhaust flowing through SOₓ removing device 55 and filter 60 gradually, for example, from 500° C. to 650° C. in about 5-20 minutes. The SOₓ removing material may be properly selected such that the stable sulfates may also be decomposed during regeneration of filter 60. The SOₓ removing material may be further selected such that the decomposition of the sulfur compounds may be substantially complete within the same regeneration time frame of filter 60, e.g., within about 5-20 minutes, and within the same temperature range, e.g., 500° C. to 650° C. In this way, SOₓ removing device 55 and filter 60 both may be regenerated substantially simultaneously.

The regeneration process of SOₓ removing device 55 and filter 60 may be controlled by controller 100 configured to be in communication with regeneration device 65. Controller 100 may regulate the operation of regeneration device 65 to increase the exhaust temperature to a particular level within a particular time frame, and for a particular duration.

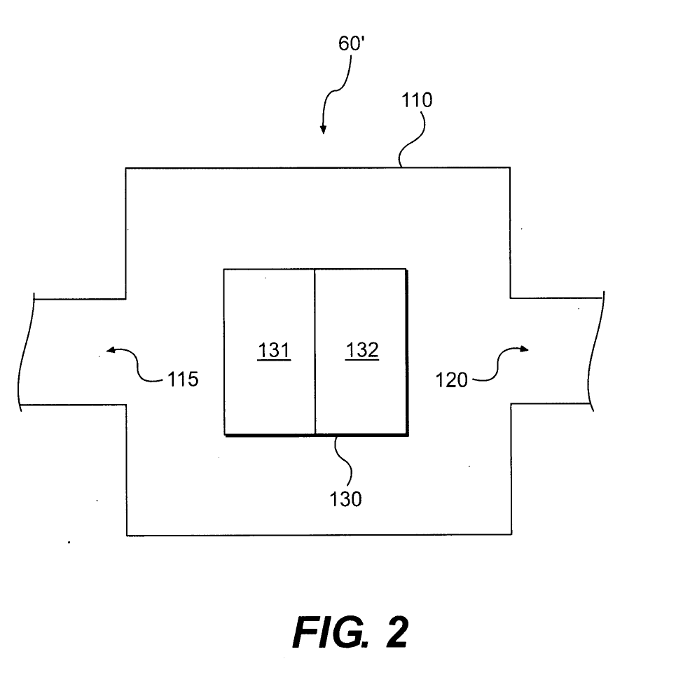

In some embodiments, SOₓ removing device 55 and filter 60 may be integrated as a single treatment device 60′, as shown in FIG. 2. In these embodiments, single treatment device 60′ may replace SOₓ removing device 55 and filter 60 that are shown in FIG. 1. Treatment device 60′ may include a housing 110 having an inlet 115 and an outlet 120, and a filter substrate 130 disposed within housing 10. Filter substrate 130 may be configured to remove particulate matter, and may be coated with an SOₓ removing material for absorbing or adsorbing SOₓ. Alternatively, in some embodiments, filter substrate 130 may include a first substrate 131 for removing particulate matter, and a second substrate 132 coated with the SOₓ removing material discussed above for removing SOₓ. The first and second filter substrates 131 and 132 may be arranged in series within housing 110. Therefore, treatment device 60′ may integrate both the SOₓ removing capability and particulate matter removing capability within a single component.

### INDUSTRIAL APPLICABILITY

The disclosed exhaust system may be utilized in any power system application, where exhaust is produced from combustion of a sulfur-containing fuel. Particularly, the disclosed exhaust system may be used to protect exhaust components from corrosion caused by sulfuric acid formed from SOₓ contained within the combustion byproducts. SOₓ removing device 55 may remove SOₓ from the exhaust before the exhaust is recirculated back into the engine, thereby reducing the formation of sulfuric acid within recirculation circuit 70 when the exhaust is cooled.

Referring to FIG. 1, air and fuel may be supplied to engine 20 through intake manifold 35, which may further distribute the received air and fuel mixture to combustion chambers defined by cylinders 40. The air and fuel mixture may then be combusted within engine 20 to produce power and exhaust as a byproduct. The exhaust may contain a plurality of constituents, such as NOₓ, SOₓ, oxygen, unburned fuel, particulate matter, etc. The exhaust may be discharged from engine 20 through exhaust manifold 45 to passageway 50 of exhaust system 30. The exhaust may flow through or past regeneration device 65, SOₓ removing device 55, filter 60, and various exhaust treatment devices not shown in FIG. 1, and may be conditioned by these devices.

After being conditioned by the exhaust treatment devices of exhaust system 30, SOₓ in the exhaust may have been reduced. A portion of the SOₓ-reduced exhaust may be directly discharged to the atmosphere, another portion of the SOₓ-reduced exhaust may be directed back into engine 20 through recirculation circuit 70. Valve 105, the operation of which may be regulated by controller 100, may open to allow the exhaust to flow through recirculation circuit 70, or close to inhibit exhaust flow therethrough. When flowing through recirculation circuit 70, the exhaust may be cooled by cooling device 75. If the exhaust contains SOₓ, sulfuric acid may form and attach to surfaces of cooling device 75, recirculation circuit 70, and engine 20.

SOₓ removing device 55 may significantly reduce the SOₓ content from the exhaust before the exhaust is directed back to engine 20 through recirculation circuit 70, thereby reducing the formation of sulfuric acid within recirculation circuit 70 and engine 20. As SOₓ is removed from the exhaust and stored in SOₓ removing device 55 as sulfates, stable sulfates may attach to surfaces of substrate 95 and reduce its SOₓ removal capacity. Particulate matter, when removed from the exhaust by the filter substrate of filter 60, may accumulate in filter 60 and block the exhaust flow, resulting in increased backpressure of exhaust system 30 that adversely affects engine performance. Therefore, after a period of time in service, one or both of the SOₓ removing device 55 and filter 60 may become saturated.

The particulate matter stored within filter 60 may be burned away and the sulfur compounds within SOₓ removing device 55 may be decomposed when heated. Therefore, both SOₓ removing device 55 and filter 60 may be regenerated substantially simultaneously using regeneration device 65. Regeneration device 65 may produce heat to increase the temperature of the passing exhaust flow. When the heated exhaust passes through SOₓ removing device 55 and filter 60, the exhaust may increase the temperatures of both SOₓ removing device 55 and filter 60. In one example, the temperature of the exhaust is increased from about 500° C. to about 650° C., and maintained at about 650° C. for about 15 minutes during a regeneration event.

Regeneration device 65 may be controlled by controller 100 so that the temperature of the exhaust is increased in a predetermined manner. For example, the temperature may be increased at a constant rate, such as an increase of about 10° C. every minute, or at a variable rate, such as an increase from about 500° C. to 600° C. in about 5 minutes, and from about 600° C. to 650° C. in about 10 minutes. Controller 100 may also regulate regeneration device 65 such that the temperature may stay at a value for a period of time, for example, at about 600° C. for 2 minutes. The regeneration event may last for a predetermined duration of time, for example, about 5-20 minutes. After the predetermined duration of time has elapsed, the regeneration event may be terminated, for example, by shutting down regeneration device 65. Alternatively, the regeneration event may be terminated based on the results of the regeneration event. For example, sensors, virtual sensors, or indicators may be associated with SOₓ removing device 55 and/or filter 60, which may indicate a progress of the regeneration event. Once the regeneration event has been adequately completed, for example, about 90% or more of the particulate matter in filter 60 has been burned away, or about 90% or more of the sulfur compounds in SOₓ removing device 55 have been decomposed, as indicated by the sensors, controller 100 may shut down regeneration device 65. The particulate matter may continue to burn and the sulfur compounds may continue to decompose due to residual heat even after regeneration device 65 is shut down. The regeneration event may be performed on a regular basis, for example, once every 8-10 hours of service time of power system 10.

During the regeneration event, the decomposed sulfur compounds may release SOₓ back into the exhaust. Therefore, before starting the regeneration of filter 60 and SOₓ removing device 55, controller 100 may close valve 105 such that recirculation circuit 70 is inhibited from recirculating the exhaust when SOₓ removing device 55 and filter 60 are being regenerated. The SOₓ released during the regeneration event may be discharged to the atmosphere directly from exhaust system 30. After the regeneration event has been terminated and regeneration device 65 has been shut down by controller 100, controller 100 may re-open valve 105 to allow exhaust to flow through recirculation circuit 70.

By utilizing the disclosed SOₓ removing device, SOₓ in the exhaust may be significantly reduced, thereby protecting components of recirculation circuit 70 and engine 20 from corrosion due to sulfuric acid formed by SOₓ. By regenerating SOₓ removing device 55 and filter 60 substantially simultaneously without shutting power system 10 down, time for servicing SOₓ removing device 55 and filter 60 may be reduced. Furthermore, regenerating SOₓ removing device 55 instead of periodically replacing it can also reduce maintenance time and cost.

It will be apparent to those skilled in the art that various modifications and variations can be made in the disclosed exhaust system. Other embodiments will be apparent to those skilled in the art from consideration of the specification and practice of the disclosed embodiments herein. It is intended that the specification and examples be considered as exemplary only, with a true scope of the disclosure being indicated by the following claims.

What is claimed is:

1. An exhaust system for an engine, comprising:
a passageway configured to receive exhaust from the engine;
a recirculation circuit configured to recirculate exhaust from the passageway back into the engine;
an SOₓ removing device disposed within the passageway upstream of the recirculation circuit;
a filter disposed within the passageway to remove particulate matter from the exhaust; and
a regeneration device configured to substantially simultaneously regenerate the SOₓ removing device and the filter.

2. The exhaust system of claim 1, wherein the SOₓ removing device includes an SOₓ removing material configured to react with SOₓ to form a stable sulfate.

3. The exhaust system of claim 2, wherein the SOₓ removing material is selected from a group of materials consisting of iron, copper, and aluminum.

4. The exhaust system of claim 2, wherein the SOₓ removing device includes a substrate, and the SOₓ removing material is coated on the substrate.

5. The exhaust system of claim 2, wherein the stable sulfate is decomposed when heated to a temperature range by the regeneration device.

6. The exhaust system of claim 5, wherein the temperature range is about 500° C. to 650° C.

7. The exhaust system of claim 5, wherein combustion of the particulate matter occurs within the temperature range.

8. The exhaust system of claim 1, further including a valve disposed within the recirculation circuit, and a controller configured to regulate the valve and inhibit recirculation of exhaust when the SOₓ removing device and the filter are being regenerated.

9. The exhaust system of claim 1, further including a cooling device disposed within the recirculation circuit.

10. The exhaust system of claim 1, wherein the SOₓ removing device and the filter are integrated into a single treatment device.

11. The exhaust system of claim 10, wherein the single treatment device includes a filter substrate configured to remove particulate matter from the exhaust and coated with an SOₓ removing material.

12. The exhaust system of claim 10, wherein the single treatment device includes a first filter substrate configured to remove particulate matter from the exhaust and a second filter substrate coated with an SOₓ removing material.

13. The exhaust system of claim 1, wherein the filter is located upstream of the SOₓ removing device.

14. The exhaust system of claim 1, further including a controller configured to be in communication with the regeneration device to control regeneration of the SOₓ removing device and the filter.

15. The exhaust system of claim 1, wherein a regeneration duration of the SOₓ removing device and the filter is about 5-20 minutes.

16. A method of treating exhaust from an engine, comprising:
removing SOₓ from the exhaust;
directing SOₓ-reduced exhaust back into the engine;
collecting particulate matter from the exhaust; and
heating the exhaust to substantially simultaneously improve an SOₓ removal capacity and reduce an amount of collected particulate matter.

17. The method of claim 16, further including inhibiting the directing of exhaust back to the engine when the exhaust is being heated.

18. The method of claim 16, wherein heating includes heating the exhaust to a temperature range of about 500° C. to 650° C.

19. The method of claim 16, wherein heating includes heating for about 5-20 minutes.

20. A power system, comprising:
an engine configured to combust fuel and produce exhaust;
a passageway configured to receive exhaust from the engine;
a recirculation circuit configured to recirculate exhaust from the passageway back into the engine;
an SOₓ adsorber disposed within the passageway upstream of the recirculation circuit;
a particulate filter disposed within the passageway to remove particulate matter from the exhaust;
a regeneration device configured to substantially simultaneously regenerate the SOₓ adsorber and the particulate filter;
a valve disposed within the recirculation circuit; and
a controller configured to regulate the valve to inhibit recirculation of exhaust when the SOₓ adsorber and the particulate filter are being regenerated.
